(19) United States
(12) Patent Application Publication
(10) Pub. No.: US 2024/0356418 A1
(43) Pub. Date: Oct. 24, 2024

(54) SYSTEM AND METHOD FOR INSERTING I-PINS INTO A STATOR OR ROTOR WINDING ASSEMBLY

(71) Applicant: Tecnomatic S.p.A., Corropoli (Teramo) (IT)

(72) Inventors: Francesco LUCCHETTI, Corropoli (Teramo) (IT); Maurilio Micucci, Corropoli (Teramo) (IT); Giuseppe Ranalli, Corropoli (Teramo) (IT)

(21) Appl. No.: 18/420,238

(22) Filed: Jan. 23, 2024

(30) Foreign Application Priority Data
Apr. 18, 2023 (IT) 102023000007470

(51) Int. Cl. H02K 15/06; B21F 3/02

(52) U.S. Cl. CPC H02K 15/064; B21F 3/02

(57) ABSTRACT

A system and a method for inserting I-pins into a stator or rotor winding assembly are provided. The system has a cylindrical containment for hairpins and a circular inner containment axially inserted into the cylindrical containment for hairpins having a set of radial slots, an upper circular plate with one or more upper cam recesses, a lower circular plate with one or more lower cam recesses, and a vertical wall extending from the upper circular plate to the lower circular plate and rotatably mounted relative thereto. The upper and lower cam recesses accommodate a leg of the I-pins. The vertical wall has one or more voids positioned so that, upon rotation of the vertical wall with respect to the upper and lower circular plates, the upper and lower outlets lead into the voids releasing the leg in a radial slot of the cylindrical containment for hairpins.

### CROSS REFERENCE TO RELATED APPLICATION

This application claims priority to and benefit of Italian Patent Application No. 102023000007470 filed Apr. 18, 2023, the contents of which are incorporated by reference in their entirety.

### FIELD OF THE INVENTION

The present invention relates to a system and method for inserting I-pins into a stator or rotor winding assembly.

### BACKGROUND ART

One of the ways of making flat-wire stator windings for electric motors is to cut conductor parts, bend them into suitable shapes, insert them into the stator pack, and join the conductor parts with welding joints according to a wiring diagram.

Names are defined according to the shapes and functions taken by the individual parts of a bent conductor.

To date, the most common flat-wire conductor shape is that shown in FIG. 1 and is commonly referred to as a “hairpin” 100 (with two legs, but there are some with a greater number of legs, such as the W-pin). FIG. 2, on the other hand, shows a so-called “I-pin” 200 because the shape seems that of the letter “I” (a single leg). From the electrical point of view, its function inside the winding 600 (see FIG. 4) is to be the input and/or output of the same winding, and for this reason it is also referred to as a phase or route terminal. It should be noted that the term hairpin often mistakenly refers to all the shapes that the conductor can take before being positioned inside a winding 600, thus including the I-pin itself.

FIG. 2 shows the main feature of the I-pin 200, which is to have the straight (vertical) conductor parts 201, 202, which both end with a part without insulating enamel, one facing downwards, 203, and the other upwards, 204, unlike the hairpin 100 which has them both facing downwards. As a result, there are two oblique sections of the conductor in the hairpin 100 while there is only one in the I-pin 200.

With reference to FIG. 3, the wiring diagram of a stator winding (inserted into a containment 305) determines whether or not to use the aforesaid I-pin as well as the slot and layer position.

The term ‘layer’ means the average diameter for positioning flat wires in the stator (or rotor) slot 307, whereby outer layer 302 refers to the position of the flat wires 301 with the greatest diameter, while inner layer 306 refers to the position of the flat wires 301 with the smallest diameter, and intermediate layer 303,304 refers to all positions between the innermost layer and the outermost one.

In particular, in a wiring diagram, it is determined in which slots 307 of the stator pack the I-pins are to be inserted, and then in which layers 302-306 of the winding 600, which is shown in FIG. 4 with I-pins 200 on the inner layer and in FIG. 5 with I-pins 200 on the outer layer.

A method for the insertion into the winding 600 is determined according to the layer in which the I-pin 200 is to be inserted. Usually, in a winding 600 there are more than one and in multiple numbers with respect to the number of phases.

Various positions of the I-pins 200 inside the windings of hairpins 100 can be observed in FIGS. 4-6; in particular, FIG. 4 shows a winding 600 of hairpins 100 with I-pins 200 on the inner layer 303, FIG. 5 shows a winding 600 of hairpins 100 with I-pins 200 on the outer layer 302, and FIG. 6 shows a winding 600 of hairpins 100 with I-pins 200 on the intermediate layer 304 as well.

However, the insertion of the I-pins is not always simple and without consequence. Indeed, a first problem concerns the innermost I-pins of a winding, which, especially for small-diameter windings, are difficult to place from above by means of a robotic gripper. Indeed, the gripper would have to move radially from the inside to the outside and would interfere with the winding itself and/or other elements of the assembly apparatus.

In particular, there could be interference with hairpins next to the positions assigned to the I-pins.

This also generates the cycle time problem in the complete insertion of the I-Pin with a robot. Indeed, the “complicated” movement that would have to be performed with the robot would take too long for today's needs.

Another problem is that using a robotic gripper also causes the end portion 201, 204 of the I-pin to be limited in length.

### PURPOSE AND OBJECT OF THE INVENTION

It is the purpose of the present invention to provide a system and method for inserting I-pins into a stator or rotor winding assembly, as well as an apparatus for assembling the winding assembly and transferring it to a stator or rotor pack. The present invention relates to a system and a method according to the appended claims.

### LIST OF FIGURES

The invention will now be described by way of non-limiting illustration, with particular reference to the figures of the accompanying drawings, in which:

FIG. 1 shows the typical shape of a hairpin, according to the prior art;

FIG. 2 shows the typical shape of an I-pin, according to the prior art;

FIG. 3 shows a depiction of the layers of the flat wires, according to the prior art;

FIG. 4 shows a hairpin winding with I-pins on the inner layer, according to the prior art;

FIG. 5 shows a hairpin winding with I-pins on the outer layer, according to the prior art;

FIG. 6 shows a hairpin winding with I-pins on the intermediate layers, according to the prior art;

FIG. 7 shows an example of a multiple-part containment system, according to an embodiment of the present disclosure;

FIG. 8 shows a top view of an inner I-pin containment and positioning system, according to an embodiment of the present disclosure;

FIG. 9 shows a bottom view of an inner I-pin containment and positioning system, according to an embodiment of the present disclosure;

FIG. 10 shows the insertion of I-pins into the inner containment slots, where for ease of visualization the hairpins already inserted are not shown, according to an embodiment of the present disclosure;

FIG. 11 shows the I-pins in the final position in the winding, according to an embodiment of the present disclosure;

FIG. 12 shows a perspective view of an inner containment according to an embodiment of the present disclosure, in which multiple cams (four cams are shown, but there can be more or fewer) are provided for the simultaneous insertion of a corresponding number of I-pins;

FIG. 13 shows a step of the insertion of an I-pin on the outermost layer, according to an embodiment of the present disclosure;

FIG. 14 shows a further step of the insertion of an I-pin on the outermost layer, where the leg of the I-pin is inside the slot of the winding containment, according to an embodiment of the present disclosure;

FIG. 15 shows a top view of the situation in FIG. 13;

FIG. 16 shows a top view of a step in which multiple I-pins are inserted into a single cam, according to an embodiment of the present disclosure;

FIG. 17 shows a perspective view of an outer containment according to an embodiment of the present disclosure, where multiple cams (four cams are shown, but there can be more or fewer) are provided for the simultaneous insertion of a corresponding number of I-pins;

FIG. 18 shows a top view of the situation in FIG. 17;

FIG. 19 shows a step of inserting the winding formed by the containment, according to an embodiment of the present disclosure; and

FIG. 20 shows a multiple-station machine for forming a stator winding, according to an embodiment of the present disclosure.

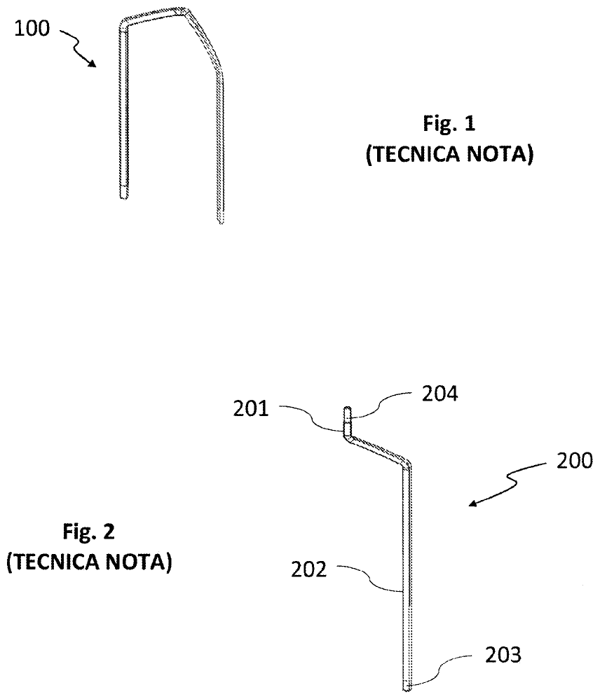

It is worth noting here that elements of different embodiments can be combined together to provide further embodiments without restrictions respecting the technical concept of the invention, as those ordinarily skilled in the art will effortlessly understand from the disclosure.

Moreover, the present disclosure also makes reference to the prior art for its implementation, as for the detail features not described, such as elements of minor importance usually used in the prior art in solutions of the same type, for example.

When introducing an element, it always means that there can be “at least one” or “one or more”.

When a list of elements or features is given in this disclosure, it is understood that the finding according to the invention “comprises” or alternatively “consists of” such elements.

When listing features within the same sentence or bulleted list, one or more of the individual features can be included in the invention without connection to the other features in the list.

Two or more of the parts (elements, devices, systems) described above can be freely associated and considered as kits of parts according to the invention.

### DETAILED DESCRIPTION

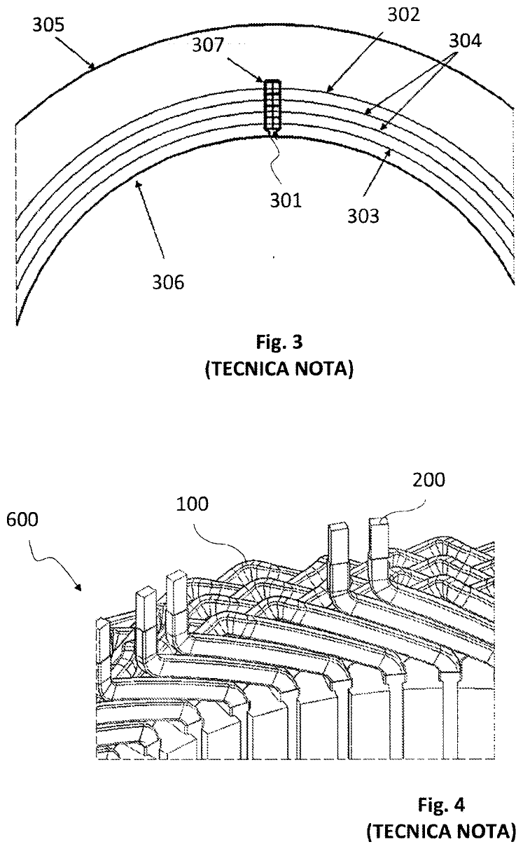

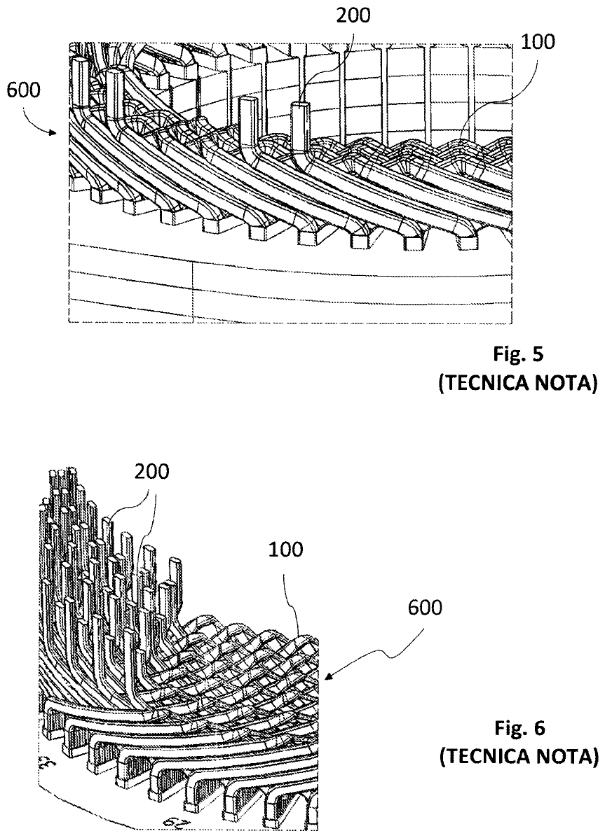

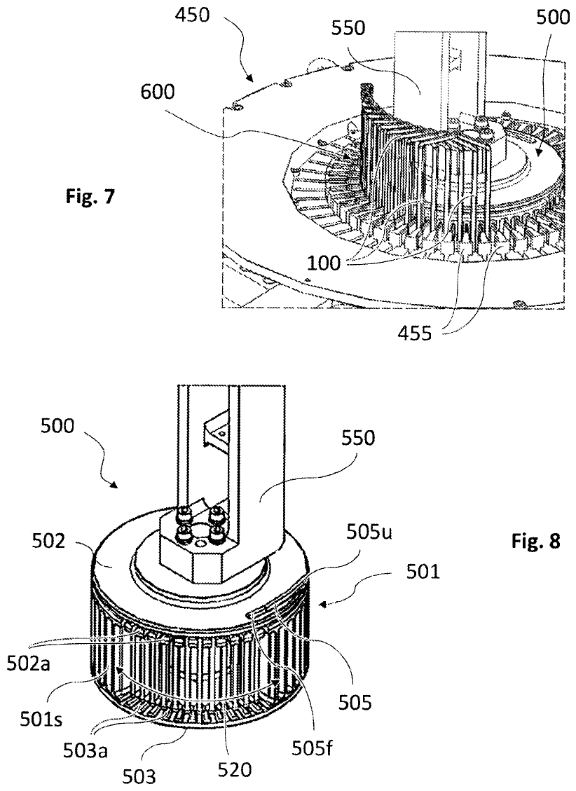

A system for inserting I-pins 200 according to an embodiment of the present disclosure will be now illustrated, in the case in which they are to be inserted into the innermost layer 303 of the winding 600 (taking the traditional context shown above in FIG. 3 as an example). For this purpose, reference will also be made to a containment system which can be made in various manners, such as with retractable radial fingers, as disclosed in patent application PCT/IB2023/052123 to the Applicant, which is incorporated herein in its entirety by reference. See also FIG. 7.

With reference to FIG. 7, according to an aspect of the present disclosure, the winding 600 can already be partially formed, i.e., some of the hairpins 100 forming the winding 600 can already be positioned in the containment system 450, the slots of which are formed between radially retractable elements or fingers or positioners 455. The containment 450 ensures that the I-pins 200, which will be inserted later, are supported on the plane transverse to the rotation axis of the containment. Regarding the vertical positioning (along said rotation axis) of the hairpins/I-pins, it is typically possible to use a support plate (not shown) below the free ends of the inserted hairpins.

The function of the containment system 450 is to keep each single hairpin in a stable position, i.e., to prevent the hairpin from falling toward the inside or toward the outside of the winding 600. Moreover, it must allow inserting all types of hairpins which form a winding 600.

A containment system as a single piece according to the prior art would have the disadvantage of not being capable of removing or moving the various parts serving the support functions for the hairpin. Therefore, according to the present disclosure, it is advantageous to use a containment system formed as several groups of parts, which individually perform the containment functions toward the inside of the winding 600, toward the outside, and downwards.

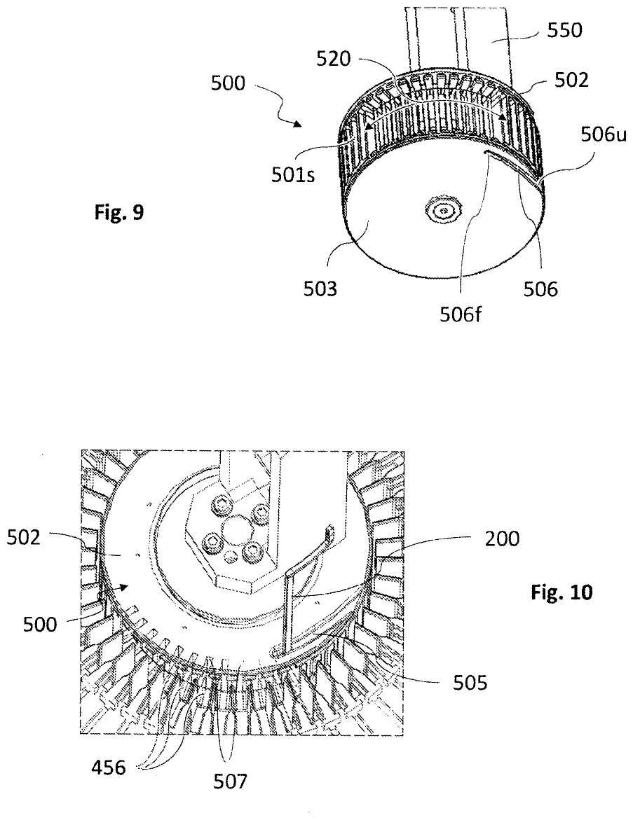

In particular, as it can be seen in FIG. 7, a central containment assembly 500, positioned axially to the annular containment 450, can be provided. The central containment 500 performs the dual function of inner containment for hairpins and positioning of I-pins. FIGS. 8 and 9 show how this assembly is composed of.

The central containment assembly 500 comprises two upper 502 and lower 503 plates (not to be confused with plate for supporting the legs of the hairpins) between which a cylindrical inner containment (vertical wall) 501 is inserted and connected. The central containment assembly 500 is configured to rotate the cylindrical inner containment part 501 and keep the two upper 502 and lower 503 plates fixed, or vice versa. The cams 505 and 506 are provided as notches to the plates 502 and 503, respectively, and have a closed end 505f, 506f and an outlet 505u, 506u. They actually are cam-shaped guides for the legs of the I-pins 200.

The cylindrical inner containment 501 can be made in various manners. For example, it can be a continuous wall (not shown) or one with vertical slits 501s, which allow for a possible overtravel of radially retractable fingers 455. However, as we shall see, there should be cylindrical sectors 520 in which such a wall is missing, in order to be able to make the I-pin exit from the outlets 505u, 506u when they are aligned with a cylindrical sector without a wall.

The central containment assembly 500 can be vertically moved by an arm 550 connected to the upper plate 502.

The insertion method according to the present disclosure provides for the I-pins 200 to be transported, by any means, close to the aforesaid inner containment assembly 501 and housed inside the slots 507 obtained in the inner containment 501, as it can be seen in FIG. 10. As shown precisely in FIG. 10, through the rotation of the cylindrical inner containment 501 and the concomitant action of the cams 505, 506 obtained in the two respective upper and lower fixed plates 502, 503, the I-pins 200 are brought to their final position inside the winding 600.

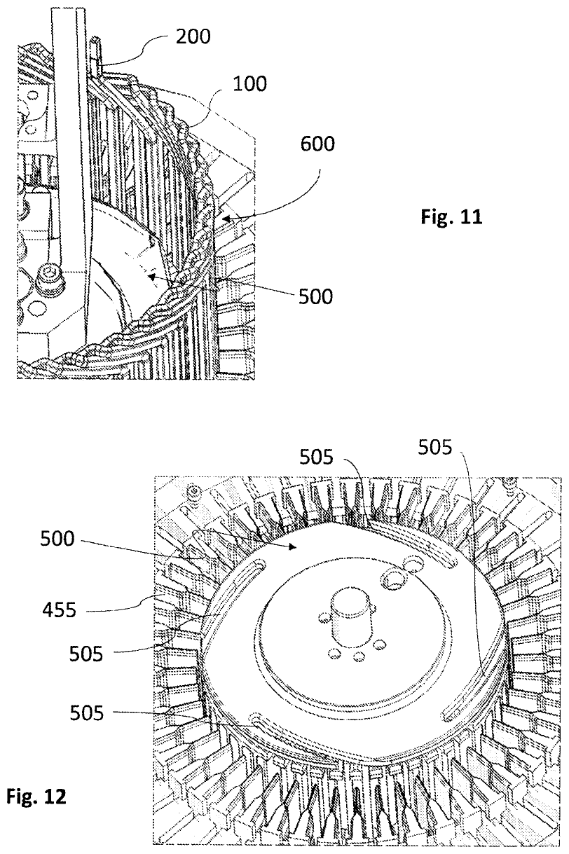

In other words, once the I-pin 200 is fully inserted into its own inner containment housing slot 507, the rotation of the cylindrical inner containment 501 occurs, which together with the cams 505, 506 of the upper 502 and lower 503 plates, respectively, create the thrust which moves the I-pin 200 to the final outlet position thereof through the (circular sector) opening 520. Such a final position is shown in FIG. 11.

Circumferentially, the slots 507 are between the radially retractable elements 455 but inside the containment 500. This can be done with an overtravel of the retractable elements into the containment through slits 501s or in a different way.

It should be noted again that the containment 500 is open over an arc of circumference 520 since the relative rotation of the plates and the central containment will bring the cam output at this arc of circumference and thus the I-pin will be pushed into the slots 456 of the containment 450.

With reference to FIG. 8, in order to position the I-pin precisely, the face of the upper circular plate 502 facing the lower circular plate can comprise upper radial containment elements 502a arranged in a radial pattern, and the face of the lower circular plate 503 facing the upper circular plate can comprise lower radial containment elements 503a arranged in a radial pattern. The two sets of elements are not necessarily the same in shape. The upper radial containment elements 502a and the lower radial containment elements 503a are configured so as to accommodate the leg 202 of an I-pin 200 between (the slots 507) two consecutive upper 502a and lower 503a radial containment elements and to release the leg 202 exiting from said upper 505u and lower 506u outlets into a radial slot 456 of said cylindrical containment 450 for hairpins.

The insertion of the I-pins 200 can also be multiple, i.e., multiple I-pins 200 can be inserted before rotating the cylindrical inner containment 501, as shown in FIG. 12, in which the hairpins and I-pins have been omitted to illustrate the four cams of the upper plate. Once an I-pin 200 has exited from the positioning cam 505, 506, it will be in the final position thereof in the winding 600.

About the four slots, this number is entirely indicative. More precisely, whether it is the cams of the (upper or lower) inner containment or the outer containment, in a preferred case the one or more upper and lower cam recesses are a plurality of cam recesses, where:
each cam recess subtends a number M≥1 of slot pitches, with M being an integer,
between the upper and lower closed ends of a cam recess and the upper or lower outlet of the next cam recess, respectively, there is a distance of at least one slot pitch,
   and where all cam recesses of the plurality of cam recesses are arranged in sequence in a predetermined arc of circumference. The I-pins are thus confined to that arc of circumference.

The rotation of the inner cylindrical containment 501 can be continuous until the final positioning of each I-pin 200, or in discrete steps.

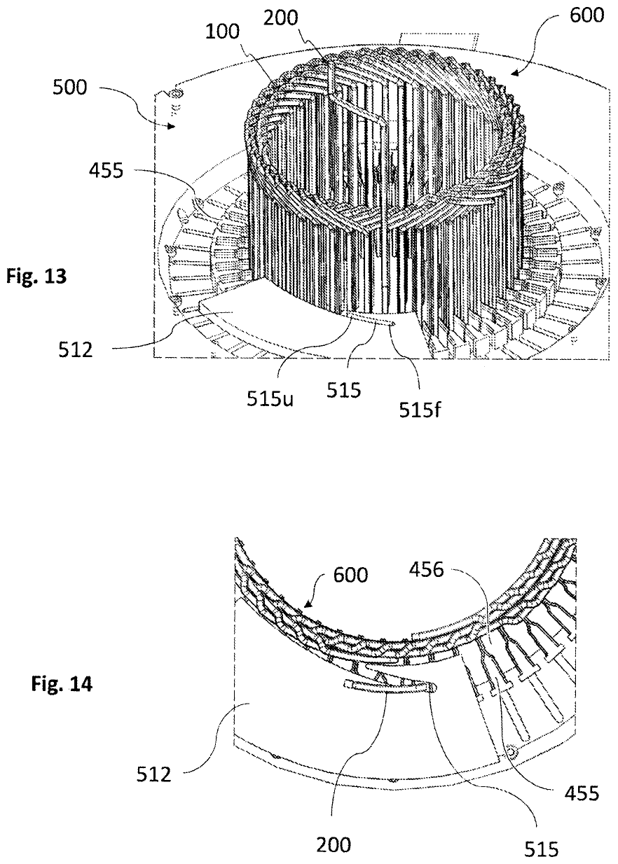

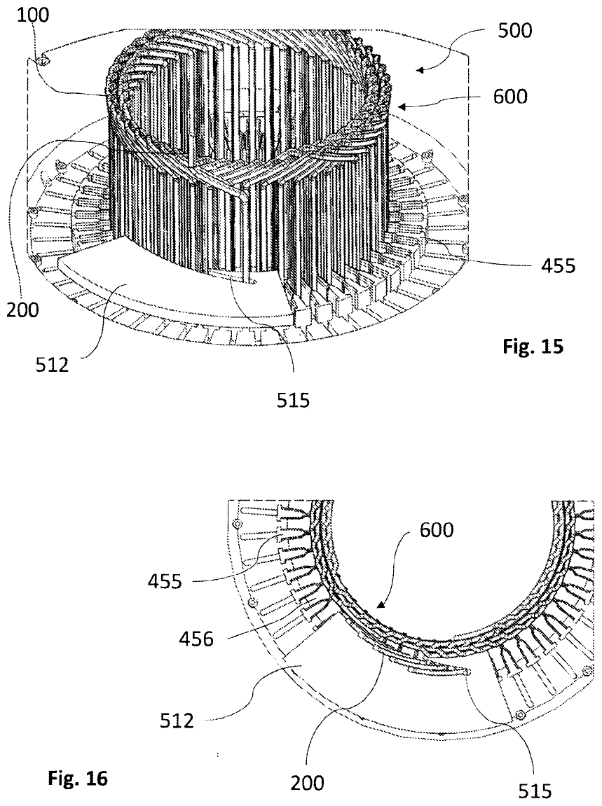

The same concept described above for the case in which the I-pins 200 are to be inserted into the innermost layer 306 of the winding 600 can be applied to the case in which they are to be inserted into the outermost layer 302 (FIG. 3), as shown in detail in FIGS. 13-16. In this case, the upper annular plate is indicated by 512 and has a cam 515. A lower plate exists and it is always a plate for supporting the free ends of hairpins or I-pins, which do not necessarily have cams.

The outer containment annular plate 512 (only partially shown) is placed above said cylindrical containment 450 for hairpins (on the side of said upper plate 502, if optionally present) or on the opposite side and, as mentioned, comprises one or more recesses 515 of outer containment annular plate with a closed end 515f and an outer containment outlet 515u, similar to those described above for the cylindrical inner containment. Such one or more recess 515 of outer containment annular plate are configured to accommodate the leg 202 of an I-pin 200 simultaneously extending into a radial slot 456 of said cylindrical containment 450 for hairpins, the one or more recesses 515 of outer containment annular plate being positioned so that, upon the relative rotation of the outer containment annular plate 512 with respects to the cylindrical containment 450 for hairpins, said outer containment outlet 515u is positioned so as to lead radially toward said inner containment 500 and thus toward the winding 600.

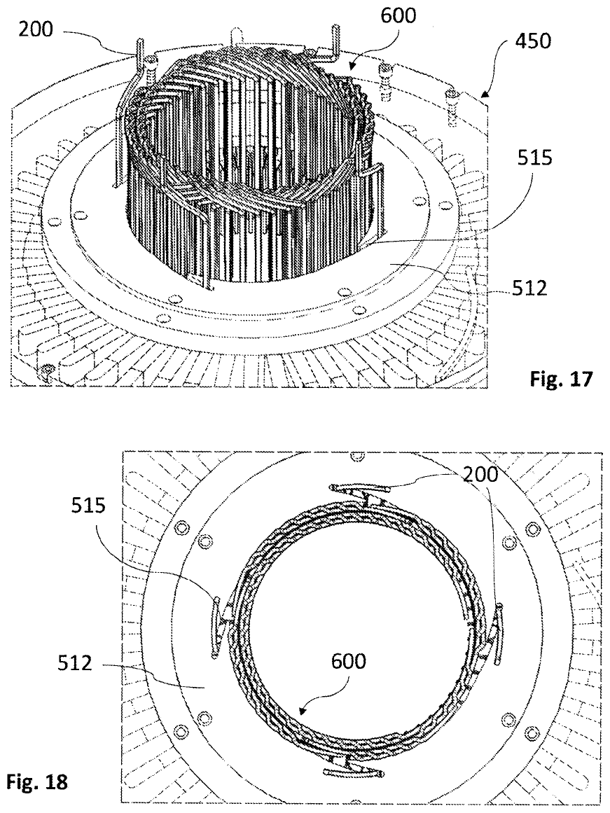

Also in this case of outer layer, the process and device allow simultaneously positioning multiple I-pins 200 in the winding 600, as shown in FIGS. 17 and 18 (even more than one I-pin for each of the recesses).

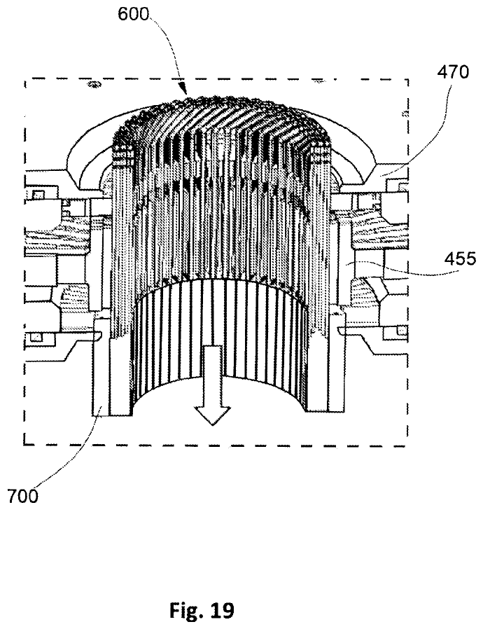

A third case, in which the I-pins 200 are to be inserted into the intermediate layer 304 (see FIG. 3), can be considered a sub-case of the case described above, in which the I-pins 200 are inserted into the innermost layer 303. Therefore, the same procedure as described above is used to mount the I-pin 200 in an intermediate layer 304. The assembled winding 600 can be transferred from the containment 450 by pushing from above directly onto the stator pack 700 inserted from below with a lifting cylinder, as in FIG. 19. The element 470 can be an additional upper containment or be part of the containment 450.

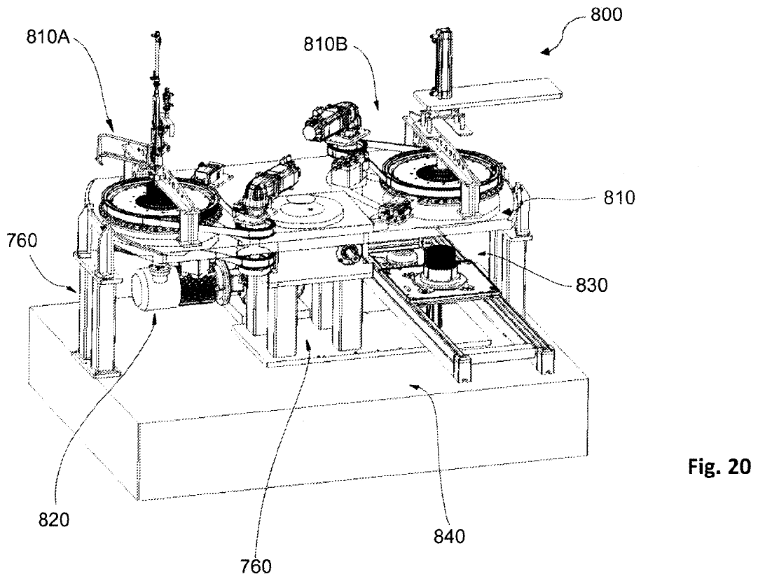

With reference to FIG. 20, an apparatus 800 is shown, which comprises an overall formation of the winding 600 with I-pins.

The apparatus 800 first comprises a rotary table, to work for example on two stations, one 810A for assembling the winding under the hairpin inserter from the top and the other 810B for inserting the winding into the stator pack, 700 simultaneously with very short rotation times of the table. It is preferable to rotate the table by 180° in one direction and then in the opposite direction so as to avoid complicated electrical and pneumatic connection systems. In all embodiments of the present invention, the two (or more) stations can be housed in corresponding holes of the rotary table. The table can also be configured to accommodate the storage (not shown) of any special basic conductors to be inserted into the transfer station.

The apparatus 800 further comprises a cylindrical containment assembly (not shown) in the station 810A, which incorporates the containment 450 described above. It is worth adding that the teeth or positioners 455 (not shown, see figures above) can be pushed radially, in turn, by sliders (not shown) which transmit motion to the positioners and are preferably provided with springs (not shown). Moreover, the containment can have a connection for the transmission onto which a specific element, which allows the movement thereof (toothed wheel or belt pulley or other), configured to rotate the containment or the plates with the cams described above.

Since the thickness of the positioners 455 (the part in contact with the conductors) radially increases, the rotation of the cam can form more or less narrow slots similar to the stator ones. Therefore, the concept is to recreate wider slots during assembly and then narrower slots to align the basic conductors, with obvious advantages in the simplicity and effectiveness of assembly and insertion of the winding into the stator pack. The positioners can be conveniently guided by special guides provided in a containment cover element (not shown). Such guides can allow a given stroke to be maintained in all steps of operation. The radial movement of the positioners can be driven by cam mechanisms. The positioner 455 can also be shaped so as to have in section a first portion of radially inner end with a fixed thickness and then a second portion flared (wedge-shaped) toward the radially outer end. Advantageously, the second portion has a first sub-portion with a first sub-length having a first flaring angle and a second sub-portion, contiguous to said first sub-portion, with a second sub-length having a second flaring angle.

Again, the apparatus 800 in FIG. 20 optionally comprises an inner containment support assembly, e.g., with a fixed support (not shown) integral with the rotary table and a support structure which can be equipped depending on the size of the winding to be processed, in which to put the containment 450 with the inner containment 500. For example, the inner containment 500 (adapted to prevent the basic conductors of the winding from falling radially inward and to insert the I-pins, see above) is supported by means of a support (not shown) rigidly connected to the fixed support, which connects the two assembly and insertion positions on the rotary table 810 in the 180° configuration.

A motor unit 820 of the cylindrical containment can allow both the entire cylindrical containment 450 and only the cylindrical wall of the inner containment 500 to rotate, through appropriate transmission means.

The apparatus 800 can comprise a stator positioning assembly 830 for the insertion of the winding, which aims at positioning the stator to receive the basic conductors and the I-pins within its slots (complete winding, see FIG. 19). It is devised to push the basic conductors from the top down through a single plane which simultaneously pushes all the conductors, and thus also serves the function of bringing the nape (part of the winding with the bridge portions of the hairpins) onto a single horizontal plane.

The foil-pack positioning and winding transfer assembly 830 can comprise means for opening and closing thrust half-rings (not shown) in order to avoid interference with other elements. The thrust means comprise means configured to move the two half-rings on a plane perpendicular to the winding axis from an open position to a closed position in which they form a single thrust disc of said head ends.

Finally, there is a base frame assembly 760 configured to take the rotary table 810 and all elements interacting therewith to a reference height. Table centering rollers and the stator pack raiser (not shown) can be fixed to this base frame, while the table rotation motor can be placed under the rotary table 810.

In an aspect of the present disclosure, the procedure uses an apparatus 800 and comprises the following steps:
1. inserting I-pins 200 into the innermost crown by means of the device 810A described above;
2. inserting I-pins into the intermediate crowns by means of the device 810A described above;
3. inserting one or more I-pins 200 into the outermost crown by means of the I-pin insertion device 512 described above;
4. moving the partially assembled winding 600 to position 810B, by means of the rotation of the rotary table 810; and
5. inserting the winding 600 into the stator pack.

### ADVANTAGES OF THE INVENTION

With the method and system according to the present disclosure, the insertion of the I-pins is simple and without consequence. Indeed, without using a robotic gripper, the inner I-pins of a winding are easily positionable without interfering with the rest of the apparatus, the other I-pins, and/or the other hairpins.

Again, with the method and system according to the present disclosure, the problems of high cycle time that occur with traditional methods, e.g., with a robot, which has to make a more complicated movement, are overcome.

Moreover, since the apparatus acts in the center of the I-pins, the ends can be of any length, removing a limitation of the prior art.

Again, the system allows the I-pins to be inserted in the same station, which allows assembling a complete winding, thus without movements between stations.

Preferred embodiments have been described above and some variants of the present invention have been suggested, but it is understood that those skilled in the art may make modifications and changes without departing from the related scope of protection, as defined by the appended claims.

What is claimed is:

1. A system for inserting I-pins into a winding assembly for a stator or rotor, comprising a cylindrical containment for hairpins, wherein the system further comprises a cylindrical inner containment axially inserted into the cylindrical containment for hairpins which comprises a series of radial slots sequentially spaced apart by one slot pitch, wherein the cylindrical inner containment further comprises:
an upper circular plate with one or more upper cam recesses having an upper closed end and an upper outlet on an outer circular perimeter thereof;
a lower circular plate with one or more lower cam recesses having a lower closed end and a lower outlet on an outer circular perimeter thereof;
a vertical cylindrical wall, which extends from the upper circular plate to the lower circular plate and is rotatably mounted with respect to said upper circular plate and lower circular plate;
and wherein:
the upper circular plate and the lower circular plate are mutually integral;
the one or more upper and lower cam recesses are corresponding in number and correspondingly positioned so as to be configured to insert a leg of at least one I-pin in both recesses;
the vertical cylindrical wall is not continuous and comprises one or more voids, in a number corresponding to said one or more upper cam recesses, along an entire vertical extension of an arc of circumference, the one or more voids being positioned so that, upon relative rotation of the vertical cylindrical wall with respect to said upper circular plate and lower circular plate, said upper and lower outlets are positioned to lead into the arc of circumference of said one or more voids;
a face of the upper circular plate facing the lower circular plate comprises upper radial containment elements arranged radially;
a face of the lower circular plate facing the upper circular plate comprises lower radial containment elements arranged radially; and
the upper radial containment elements and the lower radial containment elements are configured to accommodate the leg of the at least one I-pin between two consecutive upper and lower radial containment elements and to release the leg exiting from said upper and lower outlets into a radial slot of said cylindrical containment for hairpins.

2. The system of claim 1, wherein said cylindrical containment for hairpins comprises a series of radially retractable fingers to form the series of radial slots, and wherein said vertical cylindrical wall comprises, where said one or more voids are not present, a series of vertical slits configured for overtravel of the radially retractable fingers.

3. The system of claim 1, wherein said one or more upper and lower cam recesses are a plurality of cam recesses, wherein:
each cam recess of the plurality of cam recesses subtends a number M≥1 of slot pitches, with M being an integer,
there is a distance of at least one slot pitch between the upper and lower closed ends of a cam recess of the plurality of cam recesses and the upper or lower outlets of a next cam recess of the plurality of cam recesses, respectively,
and wherein all cam recesses of the plurality of cam recesses are arranged in sequence in a predetermined arc of circumference.

4. The system of claim 1, further comprising an outer containment annular plate, placed radially opposite to said cylindrical containment for hairpins on a side of said upper circular plate and comprising one or more cam recesses of outer containment annular plate each having a closed end and a cam recess outlet of outer containment annular plate, the one or more recesses of outer containment annular plate being configured to accommodate the leg of the at least one I-pin extending at the same time into a radial slot of said cylindrical containment for hairpins, the one or more cam recesses of outer containment annular plate being positioned so that, upon relative rotation of the outer containment annular plate with respect to the cylindrical containment for hairpins, said cam recess outlet of outer containment annular plate is positioned so as to lead radially toward said cylindrical inner containment.

5. The system of claim 4, wherein said one or more cam recesses of outer containment annular plate are a plurality of cam recesses of outer containment annular plate, wherein:
each cam recess of the plurality of cam recesses subtends a number M≥1 of slot pitches,
there is a distance of at least one slot pitch between the closed end of a cam recess of the plurality of cam recesses of outer containment annular plate and the cam recess outlet of a next cam recess of the plurality of cam recesses of outer containment annular plate,
and wherein all recesses of the plurality of cam recesses of outer containment annular plate are arranged in sequence in a predetermined arc of circumference.

6. A system for assembly and insertion in a stator or rotor pack of a winding assembly comprising one or more layers, each layer consisting of a circumferential arrangement of hairpins and/or I-pins, the hairpins comprising a head end and one or more legs with a respective free insertion end, the I-pins having a free insertion end, the system for assembly and insertion in the stator or rotor pack comprising:
a system for inserting I-pins into the winding assembly comprising
a cylindrical containment for hairpins, wherein the system further comprises a cylindrical inner containment axially inserted into the cylindrical containment for hairpins which comprises a series of radial slots sequentially spaced apart by one slot pitch, wherein the cylindrical inner containment further comprises:
an upper circular plate with one or more upper cam recesses having an upper closed end and an upper outlet on an outer circular perimeter thereof;
a lower circular plate with one or more lower cam recesses having a lower closed end and a lower outlet on an outer circular perimeter thereof;
a vertical cylindrical wall, which extends from the upper circular plate to the lower circular plate and is rotatably mounted with respect to said upper circular plate and lower circular plate;
and wherein:
the upper circular plate and the lower circular plate are mutually integral;
the one or more upper and lower cam recesses are corresponding in number and correspondingly positioned so as to be configured to insert a leg of at least one I-pin in both recesses;
the vertical cylindrical wall is not continuous and comprises one or more voids, in a number corresponding to said one or more upper cam recesses, along an entire vertical extension of an arc of circumference, the one or more voids being positioned so that, upon relative rotation of the vertical cylindrical wall with respect to said upper circular plate and lower circular plate, said upper and lower outlets are positioned to lead into the arc of circumference of said one or more voids;
a face of the upper circular plate facing the lower circular plate comprises upper radial containment elements arranged radially;
a face of the lower circular plate facing the upper circular plate comprises lower radial containment elements arranged radially; and
the upper radial containment elements and the lower radial containment elements are configured to accommodate the leg of the at least one I-pin between two consecutive upper and lower radial containment elements and to release the leg exiting from said upper and lower outlets into a radial slot of said cylindrical containment for hairpins;
removable insertion means for insertion of the hairpins and the I-pins into said winding assembly; and
rotation means for rotation of the cylindrical containment (for hairpins about a winding axis, said rotation means being configured to perform rotations by one or more discrete slot pitches about the winding axis; and
rotary rotation means for rotation of the vertical cylindrical wall with respect to the upper circular plate and the lower circular plate;
the system for assembly and insertion in the stator or rotor pack further comprising a rotating table with a first hole for housing the system for inserting I-pins into the winding assembly, wherein the rotating table
is configured to rotate about a table axis so as to take the system for inserting I-pins into the winding assembly from an assembly position of the winding assembly to an insertion position for insertion of the winding assembly into the stator or rotor pack,
has a first table surface and a second table surface opposite to said first table surface;
and wherein:
the system for inserting I-pins into the winding assembly is configured to receive said hairpins and I-pins from said free insertion ends, on a side of said first table surface in the assembly position;
feeding means of the stator or rotor pack are provided on a side of said second table surface at the insertion position; and
the system for assembly and insertion in the stator or rotor pack further comprises relative introduction means for relative introduction of said winding assembly into said stator or rotor pack in said insertion position.

7. A method for inserting I-pins into a winding assembly for a stator or rotor, the winding assembly comprising an innermost crown, an outermost crown, and one or more intermediate crowns, the method comprising
providing a system for inserting I-pins into the winding assembly, comprising a cylindrical containment for hairpins, wherein the system further comprises a cylindrical inner containment axially inserted into the cylindrical containment for hairpins which comprises a series of radial slots sequentially spaced apart by one slot pitch, wherein the cylindrical inner containment further comprises:
an upper circular plate with one or more upper cam recesses having an upper closed end and an upper outlet on an outer circular perimeter thereof;
a lower circular plate with one or more lower cam recesses having a lower closed end and a lower outlet on an outer circular perimeter thereof;
a vertical cylindrical wall, which extends from the upper circular plate to the lower circular plate and is rotatably mounted with respect to said upper circular plate and lower circular plate;
and wherein:
the upper circular plate and the lower circular plate are mutually integral;
the one or more upper and lower cam recesses are corresponding in number and correspondingly positioned so as to be configured to insert a leg of at least one I-pin in both recesses;
the vertical cylindrical wall is not continuous and comprises one or more voids, in a number corresponding to said one or more upper cam recesses, along an entire vertical extension of an arc of circumference, the one or more voids being positioned so that, upon relative rotation of the vertical cylindrical wall with respect to said upper circular plate and lower circular plate, said upper and lower outlets are positioned to lead into the arc of circumference of said one or more voids;
a face of the upper circular plate facing the lower circular plate comprises upper radial containment elements arranged radially;
a face of the lower circular plate facing the upper circular plate comprises lower radial containment elements arranged radially; and
the upper radial containment elements and the lower radial containment elements are configured to accommodate the leg of the at least one I-pin between two consecutive upper and lower radial containment elements and to release the leg exiting from said upper and lower outlets into a radial slot of said cylindrical containment for hairpins, or
providing a system for assembly and insertion in a stator or rotor pack of the winding assembly, comprising one or more layers, each layer consisting of a circumferential arrangement of hairpins and/or I-pins, the hairpins comprising a head end and one or more legs with a respective free insertion end, the I-pins having a free insertion end,
the system for assembly and insertion in the stator or rotor pack comprising:
the system for inserting I-pins into the winding assembly,
removable insertion means for insertion of the hairpins and the I-pins into said winding assembly; and
rotation means for rotation of the cylindrical containment for hairpins about a winding axis, said rotation means being configured to perform rotations by one or more discrete slot pitches about the winding axis; and
rotary rotation means for rotation of the vertical cylindrical wall with respect to the upper circular plate and the lower circular plate;
the system for assembly and insertion in the stator or rotor pack further comprising a rotating table with a first hole for housing the system for inserting I-pins into the winding assembly, wherein the rotating table
is configured to rotate about a table axis so as to take the system for inserting I-pins into the winding assembly from an assembly position of the winding assembly to an insertion position for insertion of the winding assembly into the stator or rotor pack,
has a first table surface and a second table surface opposite to said first table surface;
and wherein:
the system for inserting I-pins into the winding assembly is configured to receive said hairpins and I-pins from said free insertion ends, on a side of said first table surface in the assembly position;
feeding means of the stator or rotor pack are provided on a side of said second table surface at the insertion position; and
the system for assembly and insertion in the stator or rotor pack further comprises relative introduction means for relative introduction of said winding assembly into said stator or rotor pack in said insertion position;
inserting one or more I-pins into the innermost crown by the system for inserting I-pins into the winding assembly;
inserting one or more I-pins into the one or more intermediate crowns by the system for inserting I-pins into the winding assembly;
inserting one or more I-pins into the outermost crown by the system for inserting I-pins into the winding assembly, said system further comprising an outer containment annular plate, placed radially opposite to said cylindrical containment for hairpins on a side of said upper circular plate and comprising one or more cam recesses of outer containment annular plate each having a closed end and a cam recess outlet of outer containment annular plate, the one or more recesses of outer containment annular plate being configured to accommodate the leg of the at least one I-pin extending at the same time into a radial slot of said cylindrical containment for hairpins, the one or more cam recesses of outer containment annular plate being positioned so that, upon relative rotation of the outer containment annular plate with respect to the cylindrical containment for hairpins, said cam recess outlet of outer containment annular plate is positioned so as to lead radially toward said cylindrical inner containment;
moving the winding assembly to a previously positioned stator or rotor pack; and
inserting the winding assembly into the stator or rotor pack.
